(19) United States
(12) Patent Application Publication
(10) Pub. No.: US 2011/0206348 A1
(43) Pub. Date: Aug. 25, 2011

(54) CONTENT PROVIDING APPARATUS AND PROCESSING METHOD OF CONTENT PROVIDING APPARATUS

(75) Inventor: Yukio Numakami, Kawasaki-shi (JP)

(73) Assignee: CANON KABUSHIKI KAISHA, Tokyo (JP)

(21) Appl. No.: 13/029,982

(22) Filed: Feb. 17, 2011

(30) Foreign Application Priority Data
Feb. 23, 2010 (JP) 2010-037670

(51) Int. Cl. H04N 9/80

(52) U.S. Cl. 386/248; 386/E05.001

(57) ABSTRACT

A content providing apparatus, which provides content to a playback apparatus, acquires digital data, performs a plurality of processing types to generate content from the acquired digital data, and transmits, to the playback apparatus in response to a request from the playback apparatus, content information for enabling the playback apparatus to recognize the plurality of processing types that the content providing apparatus can perform and a processing type that has been set when the digital data is acquired from among the plurality of processing types, so as to enable the playback apparatus to determine processing to be performed from among the plurality of types of processing that the content providing apparatus can perform.

### BACKGROUND OF THE INVENTION

1. Field of the Invention

The present invention relates to a method for providing content to a playback apparatus.

2. Description of the Related Art

In recent years, increasing attention has been paid to communication standards such as Universal Pug And Play (UPnP), which enables apparatuses to be connected to one another via a home network to share and utilize content such as image data, video data, and audio data, and Digital Living Network Alliance (DLNA) based on the UPnP technology.

The DLNA standard defines a content providing apparatus called a digital media server (DMS). A DMS provides content to a digital media player (DMP) or a digital media controller (DMC) in the home network. Further, a DMS can provide content information (metadata) about content to a DMP and a DMC. The content information can contain a data scheme (for example, a file format, a codec, and resolution) that the DMS can provide.

One example of a DMS is a camera apparatus. A camera apparatus stores image content acquired by imaging in a camera file system (DCF: Design rule for Camera File System). The camera apparatus provides the content information about the image content stored in the DCF in the Digital Item Description Language-Lite (DIDL-Lite) format defined under the DLNA standard, in response to a content information acquisition request from a DMP or a DMC.

Further, the camera apparatus provides the image content stored in the DCF in the Joint Photographic Experts Group (JPEG) format, in response to a content acquisition request from a DMP or a DMC.

Japanese Patent No. 03941700 discusses that a DMS notifies a client of data schemes (for example, a file format, a codec, and resolution) that the DMS can provide to the client, which enables the client (DMP or DMC) to request content in a desired data scheme from among the data schemes that the DMS can provide.

However, this technique cannot ensure that a playback apparatus can play back content on which processing suitable for the status of the playback apparatus is performed.

For example, a DMP may not be able to play back image content on which processing suitable for the status of the DMP is performed, when the DMS applies color correction processing unsuitable for the status of the ambient light in the position where the DMP is placed.

Further, for example, a DMP may play back content that does not match the status of the playback apparatus, when the DMS distributes image content to which the DMS applies correction processing for making RAW data more colorful and sharp, although the display screen of the DMP is set to be darkened.

Further, for example, a DMP may play back content that does not match the status of the playback apparatus, when the DMS distributes image content faithful to the RAW data to the DMP having the dark display characteristic, although the DMS is capable of performing correction processing for making the RAW data more colorful and sharp.

In addition, the same issue arises when a DMS provides not only image content but also another content such as a video content and an audio content.

### SUMMARY OF THE INVENTION

According to an aspect of the present invention, an apparatus includes an acquisition unit configured to acquire digital data, a processing unit configured to perform a plurality of processing types to generate content from the acquired digital data, and a transmission unit configured to transmit, to a playback apparatus in response to a request from the playback apparatus, content information for enabling the playback apparatus to recognize the plurality of processing types that the processing unit can perform and a processing type that has been set when the digital data is acquired so as to enable the playback apparatus to determine processing type to be performed.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a configuration of a content providing system according to an exemplary embodiment of the present invention.

FIG. 2 illustrates a hardware configuration of a providing apparatus according to the exemplary embodiment of the present invention.

FIG. 3 illustrates a module configuration of the providing apparatus.

FIG. 4 illustrates an example of correction information generated by a correction information addition unit.

FIG. 5 illustrates an example of RAW data and content attribute information of image content, and processing types that the providing apparatus can perform on the RAW data

FIG. 6 illustrates an example of a structure of content information provided to a playback apparatus according to an exemplary embodiment of the present invention.

FIG. 7 is a flowchart illustrating processing when the providing apparatus acquires image data.

FIG. 8 is a flowchart illustrating processing when the providing apparatus provides content information.

FIG. 9 is a flowchart illustrating processing when the providing apparatus provides content.

FIG. 10 illustrates a module configuration of the playback apparatus according to an exemplary embodiment of the present invention.

FIG. 11 is a flowchart illustrating processing when the playback apparatus selects correction processing.

FIG. 12 illustrates an example of correction function information provided by a correction processing unit.

### DESCRIPTION OF THE EMBODIMENTS

Various exemplary embodiments, features, and aspects of the invention will be described in detail below with reference to the drawings.

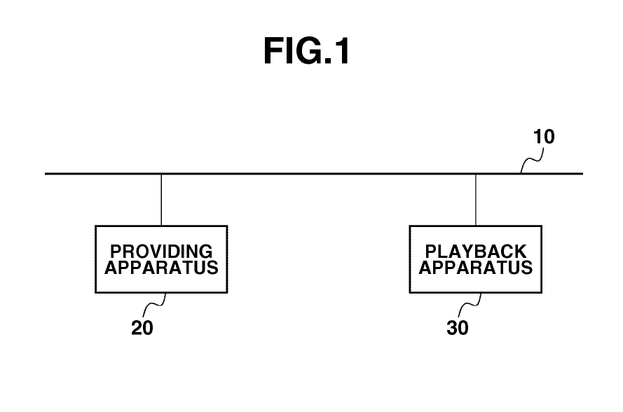

FIG. 1 illustrates an example of a configuration of a content providing system according to an exemplary embodiment of the present invention.

In the present exemplary embodiment, a providing apparatus 20 for providing content, and a playback apparatus 30 for playing back content are connected to each other via a local area network (LAN) 10. The LAN 10 is a wired LAN or a wireless LAN serving as a home network in the present exemplary embodiment. However, the network in the present exemplary embodiment may be embodied by not only a wired LAN and a wireless LAN but also a wide area network (WAN), an ad-hoc network, a Bluetooth network, a Zigbee network, and an ultra wideband (UWB) network.

The present exemplary embodiment will be described based on an example in which the providing apparatus 20 and the playback apparatus 30 are respectively a digital camera for capturing still images and a digital television for displaying still images, but the present invention is not limited thereto. For example, the present invention can be applied to such a system that the providing apparatus 20 is a digital video camera for capturing moving images, a cellular phone equipped with a built-in camera, a personal computer (PC), or an audio recorder for recording audio data. Further, the present invention can be applied to such a system that the playback apparatus 30 is an image playback apparatus such as a digital photo frame, or an audio playback apparatus such as a speaker.

The providing apparatus 20 (digital camera) serves as a content providing apparatus for providing content to the playback apparatus 30 (digital television) via the network. More specifically, the providing apparatus 20 captures an image of an object to acquire image data (digital data: RAW data). Then, the providing apparatus 20 performs, for example, correction processing, size conversion, and coding on the acquired image data (RAW data) to generate image content, and provides the generated image content to the playback apparatus 30 in the home network. Further, the providing apparatus 20 provides content information to the playback apparatus 30 in response to a content information acquisition request from the playback apparatus 30.

The content information in the present exemplary embodiment contains content attribute information and data scheme information. The content attribute information contains the shooting date and time of image data, the model name of a photographing apparatus, the resolution, the shutter speed at the time of shooting, and the identification information (for example, filename) of image data. On the other hand, the data scheme information is information about data schemes of image content that the providing apparatus 20 can provide to the playback apparatus 30. The providing apparatus 20 in the present exemplary embodiment can provide image content in a plurality of data schemes to the playback apparatus 30. For example, the playback apparatus 20 can provide image content in such a data scheme that correction processing for conversion into a monochromatic image data is applied to the image data (RAW data), no size conversion (pixel number conversion) is performed on the image data, and the image data is coded into JPEG data. Further, the playback apparatus 20 can provide image content in such a data scheme that correction processing is not applied to the image data (RAW data), size conversion for reducing the pixel number is performed on the image data, and the image data is coded into JPEG data.

The data scheme information in the present exemplary embodiment is constituted by including a plurality of res elements (elements indicating resource information) in such a manner that one res element corresponds to one data scheme. Further, each res element contains information (correction information) about a processing type that the providing apparatus 20 performs on image data (RAW data). Further, an imaging correction flag is contained in a res element of the plurality of res elements which causes execution of correction processing that has been set to the providing apparatus 20 when the providing apparatus 20 captures an object image. Further, a no-correction flag is contained in a res element of the plurality of res elements which does not cause execution of correction processing.

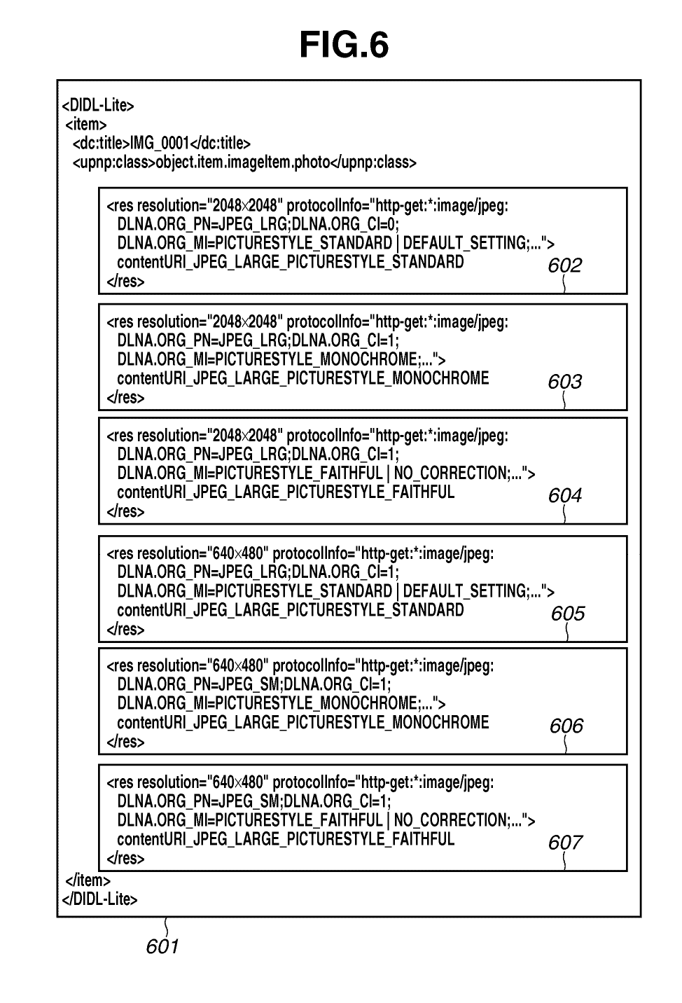

FIG. 6 indicates an example of the content information in the present exemplary embodiment. In FIG. 6, “IMG_{—}0001” is the filename of the image content. The content attribute information is omitted in FIG. 6, except for the filename.

Res elements 602 to 607 correspond to data schemes in which the providing apparatus 20 can provide image data (digital data). FIG. 6 indicates that the providing apparatus 20 can provide IMG_{—}0001 in six types of data schemes to the playback apparatus 30. Further, FIG. 6 indicates that the res elements 602 and 605 of the res elements 602 to 607, which each contain “DEFAULT_SETTING (imaging correction flag)”, are each a data scheme causing the providing apparatus 20 to perform the correction processing that has been set to the providing apparatus 20 when digital data (RAW data) is acquired. Further, FIG. 6 indicates that the res elements 604 and 607 of the plurality of res elements 602 to 607, which each contain “NO_CORRECTION (no-correction flag), are each a data scheme causing the providing apparatus 20 to perform no-correction processing on the digital data (RAW data). The providing apparatus 20 in the present exemplary embodiment transmits the content information in response to a content information request issued from the playback apparatus 30. The playback apparatus 30 can recognize the correction processing types that the providing apparatus 20 can perform on the RAW data by referring to the content information transmitted from the providing apparatus 20. The content information will be described in more detail below.

The providing apparatus 20 in the present exemplary embodiment has the functions as a DMS in a DLNA system. Especially, the providing apparatus 20 has the content directory service (CDS) function of a DMS. However, the providing apparatus 20 is not limited to an apparatus having the functions as a DMS in a DLNA system, but may be embodied by any apparatus having the function of providing content and content information into a home network or having both the functions.

The playback apparatus 30 in the present exemplary embodiment has the functions as a DMP in a DLNA system. However, the playback apparatus 30 may have the functions as a DMC in a DLNA system, not as a DMP. Further, the playback apparatus 30 is not limited to an apparatus having the functions as a DMP but may be embodied by any apparatus having the function of acquiring content and content information in a home network.

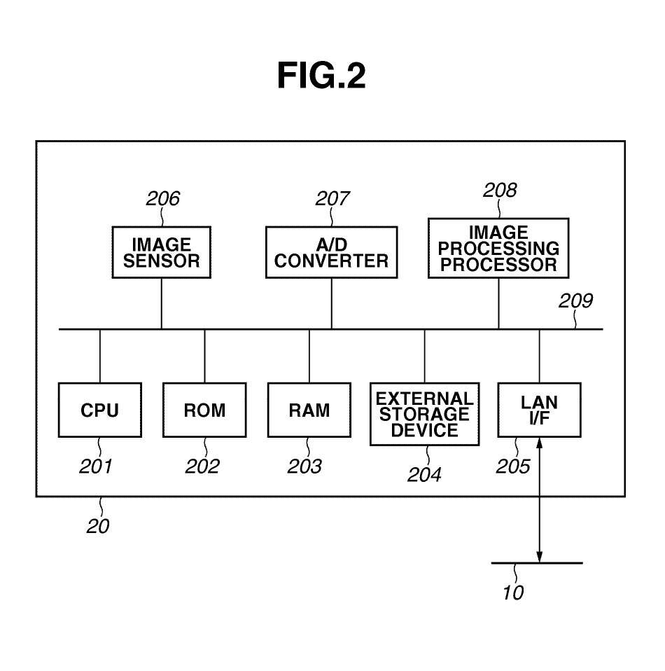

FIG. 2 is a block diagram illustrating an example of the hardware configuration of the providing apparatus 20. A central processing unit (CPU) 201 is in charge of overall control of the providing apparatus 20. A read only memory (ROM) 202 stores a program and a parameter that are not required to be changed.

A random access memory (RAM) 203 temporarily stores a program and data supplied from, for example, an external apparatus.

An external storage device 204 stores image data (RAW data) acquired from imaging and content attribute information. The content attribute information contains the shooting date and time of image data, the model name of a photographing apparatus, the resolution, and the shutter speed at the time of shooting. Further, the content attribute information contains a correction processing type that has been set to the providing apparatus 20 when the image data is acquired. Concrete examples of the external storage device 204 include a hard disk and a memory card fixedly mounted on the providing apparatus 20. Further, concrete examples of the external storage device 204 include a medium detachably attached to the providing apparatus 20, such as an optical disk such as a flexible disk (FD) and a compact disc (CD), a magnetic card, an optical card, an integrated circuit (IC) card, and a memory card.

A LAN interface (I/F) 205 is in charge of communication control for enabling a connection to the LAN 10.

An image sensor 206 is an image sensor for converting light input from an object that is a shooting subject via a lens into analog electrical signal data. Concrete examples of the image sensor 206 include a charge coupled device (CCD) sensor or a complementary metal-oxide semiconductor (CMOS) sensor.

An analog/digital (A/D) convertor 207 converts analog electrical signal data acquired by the image sensor 206 into digital data. This digital data is the above-described RAW data (image data).

An image processing processor 208 performs, on RAW data, various types of correction processing (development processing) including the processing of correcting sharpness, contrast, color strength, and color tone. The RAW data is image data before this correction processing is applied thereto. Further, the image processing processor 208 generates JPEG data from image data after the correction processing is applied thereto. A system bus 209 communicably connects the units 201 to 208 to one another.

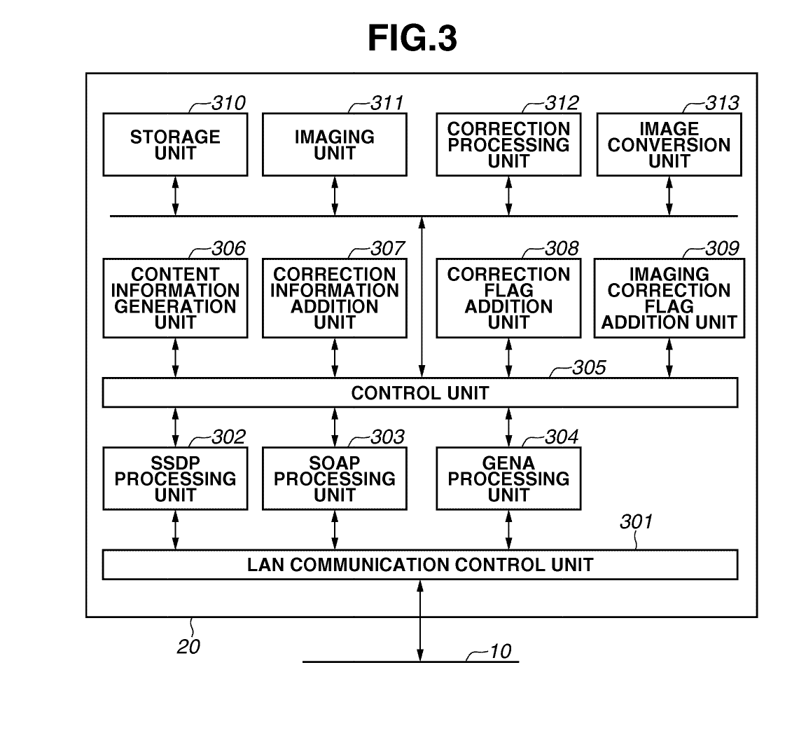

FIG. 3 is a block diagram illustrating an example of a module configuration of the providing apparatus 20 in the present exemplary embodiment.

A LAN communication control unit 301 is in charge of communication control for enabling a connection to the LAN 10.

A Simple Service Discovery Protocol (SSDP) processing unit 302 receives a packet related to SSDP from the LAN communication control unit 301, and performs the SSDP processing of UPnP. In particular, the SSDP processing unit 302 advertises the existence of the providing apparatus 20 as a DMS in the LAN 10 to DLNA apparatuses in the LAN 10. This is referred to as an alive message under SSDP. Further, the SSDP processing unit 302 discovers another UPnP service in the LAN 10. Alternatively, the SSDP processing unit 302 transmits a reply with respect to the discovery of an UPnP service from another DLNA apparatus. The present exemplary embodiment utilizes the SSDP processing, but the present invention is not limited thereto. The providing apparatus 20 may use another method such as the Web Services Dynamic Discovery (WS-Discovery) technology or the Media Access Control (MAC) address technology.

A Simple Object Access Protocol (SOAP) processing unit 303 receives a packet related to SOAP from the LAN communication control unit 301, and performs the SOAP processing of UPnP. In particular, the SOAP processing unit 303 issues a request to another UPnP service, or receives a request to an UPnP service from another DLNA apparatus and replies thereto. Especially, the SOAP processing unit 303 receives a content information request issued from the playback apparatus 30 via the LAN 10.

Further, the SOAP processing unit 303 provides content information to the playback apparatus 30 in response to a content information request from the playback apparatus 30. The present exemplary embodiment utilizes the SOAP processing, but the present invention is not limited thereto. The providing apparatus 20 may use another method for carrying out a remote object such as the Remote Procedure Call technology.

A General Event Notification Architecture (GENA) processing unit 304 receives a packet related to GENA from the LAN communication control unit 301, and performs the GENA processing of UPnP. In particular, the GENA processing unit 304 adds an event to another DLNA apparatus via the LAN 10, or subscribes to an event in an UPnP service that another DLNA apparatus has. The present exemplary embodiment utilizes the GENA processing, but the present invention is not limited thereto. The providing apparatus 20 may use another method such as the Web Services Eventing (WS-Eventing) technology or the Web Services Notification (WS-Notification) technology.

A control unit 305 is in charge of overall control of the providing apparatus 20. Further, the control unit 305 manages and controls the modules 301 to 313.

An imaging unit 311 controls the image sensor 206 and the A/D convertor 207 illustrated in FIG. 2 to acquire digital data (RAW data). Further, the imaging unit 311 generates content attribute information about RAW data. The control unit 305 stores digital data (RAW data) and content attribute information in a storage unit 310. The content attribute information contains the shooting date and time of image data, the model name of a photographing apparatus, the resolution, the shutter speed at the time of shooting. Further, the content attribute information contains a correction processing type that has been set to the providing apparatus 20 when the image data is captured.

A correction processing unit 312 performs processing for generating image content from the digital data (RAW data) acquired by the imaging unit 311 and stored in the storage unit 310. The correction processing unit 312 in the present exemplary embodiment performs correction processing (development processing) related to Picture Style. The correction processing related to Picture Style includes the processing of correcting sharpness, contrast, color strength, and color tone. However, the present invention is not limited thereto. For example, the correction processing related Picture Style may include another correction processing such as the white balance processing, the trimming processing, the noise reduction processing, and the dust delete processing. The present exemplary embodiment is being described based on an example of performing correction processing on RAW data, but the present invention is not limited thereto. The present invention may be applied to the case of performing correction processing on image data in another format such as JPEG data or bitmap data. Further, the present exemplary embodiment is being described based on an example of performing correction processing on image data, but the present invention is not limited thereto. For example, the present invention may be applied to the case of performing correction processing on another digital data such as moving image data or audio data.

Further, the correction processing unit 312 provides correction function information indicating correction processing types that the correction processing unit 312 can perform, in response to a request from a correction information addition unit 307. Further, the correction processing to be applied to RAW data as a default is set to the correction processing unit 312.

An image conversion unit 313 converts the image data on which correction processing is performed by the correction processing unit 312, into JPEG data. In other word, the digital data (image data) acquired by the imaging unit 311 turns into image content by experiencing the correction processing by the correction processing unit 312 and the conversion processing by the image conversion unit 313. The present exemplary embodiment is being described based on an example of converting RAW data into JPEG data, but the present invention is not limited thereto. The present invention may be applied to the case of converting RAW data into data in another format such as bitmap data or Graphics Interchange Format (GIF) data.

A content information generation unit 306 generates a part of the content information in the Digital Item Declaration Language (DIDL)-Lite format as illustrated in FIG. 6, when the SOAP processing unit 303 receives a content information request. More specifically, the content information generation unit 306 reads out the content attribute information stored in the storage unit 310, and then generates content information. As mentioned above, the content attribute information stored in the storage unit 310 contains the shooting date and time of image data, the model name of a photographing apparatus, the resolution, the shutter speed at the time of shooting, and the identification information (filename) of image data.

The content information generation unit 306 generates content information which is as illustrated in FIG. 6 but does not yet contain the res elements 603 to 607 and the imaging correction flag of the res element 602. The present exemplary embodiment is being described based on an example of generating content information in the DIDL-Lite format, but the present invention is not limited thereto. The present invention may utilize another format such as Atom Syndication Format.

A correction information addition unit 307 acquires the content information generated by the content information generation unit 306. Further, the correction information addition unit 307 acquires, from the correction processing unit 312, the correction function information indicating correction processing types that the correction processing unit 312 can perform on the RAW data.

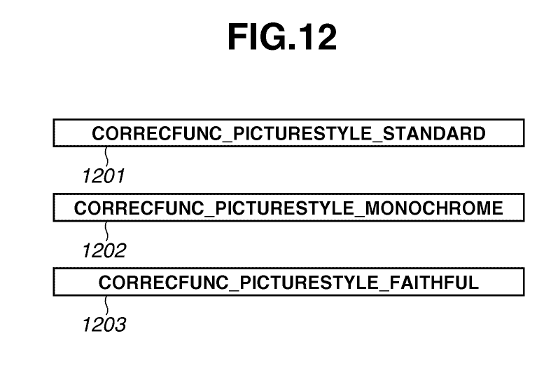

FIG. 12 illustrates an example of the executable correction function information that the correction information addition unit 307 acquires from the correction processing unit 312. As illustrated in FIG. 12, the correction information addition unit 307 acquires, for example, the correction function information related to three Picture Style settings from the correction processing unit 312. This means that the correction processing unit 312 can perform the correction processing related to the three Picture Style settings on digital data (RAW data). In the present exemplary embodiment, one piece of correction function information corresponds to correction processing of one Picture Style setting. Further, correction processing of one Picture Style setting contains processing of correcting sharpness, contrast, color strength, and color tone.

The correction function information 1201 is the correction function information corresponding to the correction processing “Picture Style/standard (CORRECFUNC_PICTURESTYLE_STANDARD”. The “Picture Style/standard” processing contains correction processing (first color conversion processing) for generating colorful and sharp image content from RAW data (improving a contrast ratio). Further, in the present exemplary embodiment, the “Picture Style/standard” processing is the correction processing that has been set at the time of shooting.

The correction function information 1202 is the correction function information corresponding to the correction processing “Picture Style/monochrome (CORRECFUNC_PICTURESTYLE_MONOCHROME”. In the “Picture Style/monochrome” processing, the correction processing unit 312 performs, on RAW data, processing containing correction processing (second color conversion processing) for generating monochromatic image content.

The correction function information 1203 is the correction function information corresponding to the correction processing “Picture Style/faithful setting (CORRECFUNC_PICTURESTYLE_FAITHFUL)”. When the “Picture Style/faithful setting” is selected, the correction processing unit 312 does not perform correction processing on RAW data.

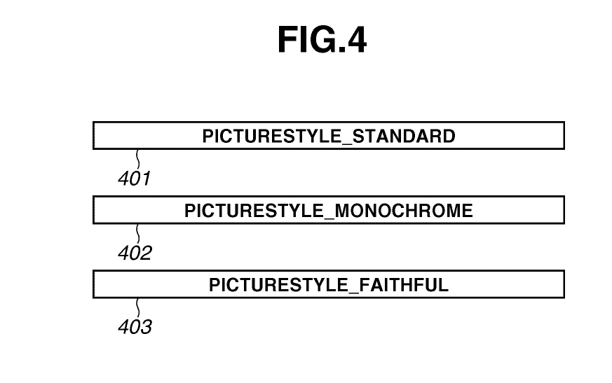

FIG. 4 illustrates an example of the correction information that the correction information addition unit 307 generates based on the executable correction function information acquired from the correction processing unit 312.

The correction information 401 is the correction information corresponding to “Picture Style/standard (PICTURESTYLE_STANDARD)”, which is generated based on the correction function information 1201. The correction information 402 is the correction information corresponding to “Picture Style/monochrome (PICTURESTYLE_MONOCHROME)”, which is generated based on the correction function information 1202. The correction information 403 is the correction information corresponding to “Picture Style/faithful setting (PICTURESTYLE_FAITHFUL)”, which is generated based on the correction function information 1203. The correction information 403 indicates that correction processing is not performed on RAW data.

In the present exemplary embodiment, each of the correction information 401 to 403 illustrated in FIG. 4 is a value formed by removing the prefix (CORRECFUNC_) from each of the correction function information 1201 to 1203 illustrated in FIG. 12, and the correction information corresponds to the correction function information one-on-one. However, the present invention is not limited thereto, and the correction information may correspond to a combination of a plurality of pieces of correction function information.

For example, more specifically, each Picture Style in the present exemplary embodiment is constituted by the processing of correcting sharpness, contrast, color strength, and color tone. Therefore, the correction processing unit 312 may provide correction function information indicating these four items to the correction information addition unit 307. In this case, the correction information addition unit 307 can generate correction information indicating Picture Style for use in the present exemplary embodiment from the combination of the above-described four items, and adds it to each res element.

The correction information addition unit 307 adds res elements based on the correction processing types that the correction processing unit 312 can perform to the content information acquired from the content information generation unit 306. More specifically, the correction information addition unit 307 adds the res elements 603 to 607 of the content information illustrated in FIG. 6. The res element 603 corresponds to a data scheme of the correction processing “Picture Style/monochrome”, the JPEG format, and 2048×2048 pixels. This means that, when the res element 603 is selected by the playback apparatus 30, the providing apparatus 20 provides image content in a size of 2048×2048 pixels in the JPEG format, which is generated by performing the correction processing “Picture Style/monochrome” on RAW data.

Further, the res element 604 corresponds to a data scheme of the correction processing “Picture Style/faithful setting”, the JPEG format, and 2048×2048 pixels. Further, the res element 605 corresponds to a data scheme of the correction processing “Picture Style/standard”, the JPEG format, and 640×480 pixels. Further, the res element 606 corresponds to a data scheme of the correction processing “Picture Style/monochrome”, the JPEG format, and 640×480 pixels. Further the res element 607 corresponds to a data scheme of the correction processing “Picture Style/faithful setting”, the JPEG format, and 640×480 pixels.

The present embodiment is being described based on an example that the providing apparatus 20 can provide image content in two sizes, but the present invention may be applied to the case that the providing apparatus 20 can provide image content in three or more sizes. For example, the providing apparatus 20 may be able to provide image content in a size of 1280×1024 pixels, in addition to 2048×2048 pixels and 640×480 pixels. In this case, the processing types indicated by the content information include the processing type with respect to first pixel number conversion processing for converting RAW data so that the pixel number of the RAW data becomes a first pixel number (1280×1024 pixels). Further, the processing types indicated by the content information include the processing type with respect to second pixel number conversion processing for converting RAW data so that the pixel number of the RAW data becomes a second pixel number (640×480 pixels).

A correction flag addition unit 308 receives the content information with the res elements added thereto by the correction information addition unit 307. Then, the correction flag addition unit 308 adds a no-correction flag to the res element of the res elements contained in the content information which does not cause correction processing to be performed on image data (RAW data). More specifically, the correction flag addition unit 308 adds a no-correction flag (NO_CORRECTION) to the res elements 604 and 607 with the faithful setting applied thereto, out of the six res elements 602 to 607 illustrated in FIG. 6.

An imaging correction flag addition unit 309 receives the content information with the res elements added thereto by the correction information addition unit 307. In the content information, the res elements that do not cause correction processing to be performed have the no-correction flag added thereto by the correction flag addition unit 308. Further, the imaging correction flag addition unit 309 acquires, from the storage unit 310, the correction processing type that has been set to the correction processing unit 312 when the image data is captured. Then, the imaging correction flag addition unit 309 adds an imaging correction flag to the res element of the res elements contained in the content information that causes execution of the correction processing that has been set to the correction processing unit 312 when the image data is captured. More specifically, the imaging correction flag addition unit 309 adds an imaging correction flag (DEFAULT_SETTING) to the res elements 602 and 605 out of the six res elements 602 to 607 illustrated in FIG. 6.

The content information generated by the content information generation unit 306, the correction information addition unit 307, the correction flag addition unit 308, and the imaging correction flag addition unit 309 is transmitted to the playback apparatus 30 by the SOAP processing unit 303. In other words, the SOAP processing unit 303 transmits the content information containing the plurality of processing types that the correction processing unit 312 can perform to the playback apparatus 30, in response to a request (content information request) from the playback apparatus 30. The content information contains the imaging correction flag by which the playback apparatus 30 can recognize the processing type that has been set when the imaging unit 311 acquires digital data (RAW data) from among the plurality of processing types that the correction processing unit 312 can perform. The playback apparatus 30, which has received the content information, can determine processing to be performed by the correction processing unit 312 from among the plurality of processing types that the correction processing unit 312 can perform.

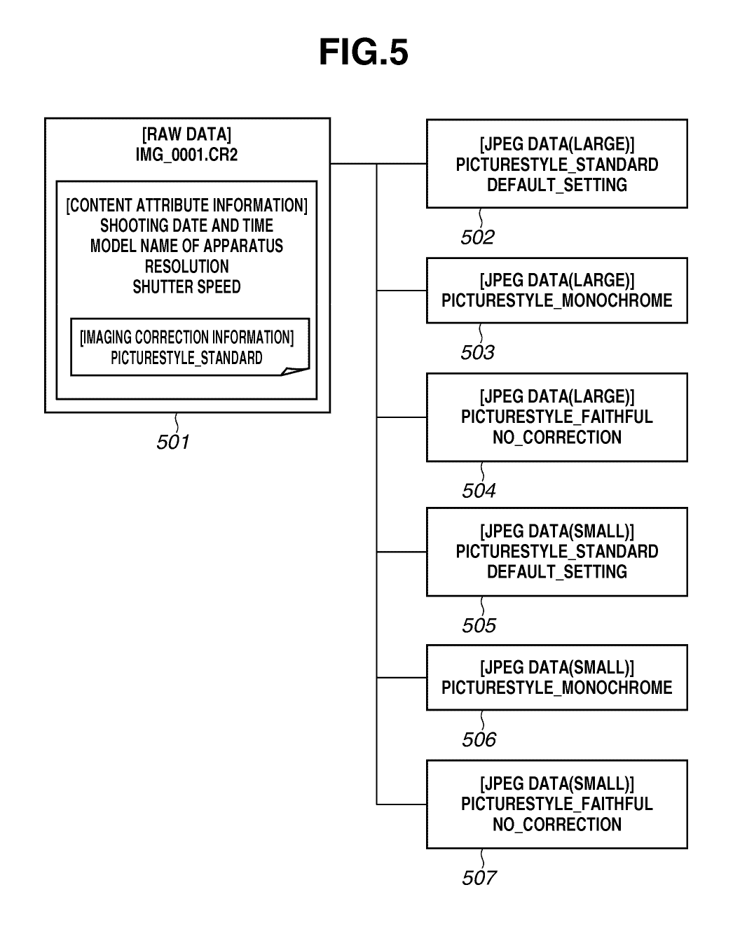

FIG. 5 illustrates an example of the RAW data and the content attribute information stored in the providing apparatus 20, and the data schemes that the providing apparatus 20 can provide to the playback apparatus 30.

The data 501 is the image data (RAW data) and the content attribute information stored in the storage unit 310 of the providing apparatus 20. The RAW data is stored in the filename of “IMG_{—}0001.CR2”. Further, the content attribute information contains “Picture Style/standard” which is correction processing that has been set when the image data is captured. Further, the content attribute information contains, for example, the shooting data and time of the image data, the model name of the photographing apparatus, the resolution, and the shutter speed at the time of shooting. However, the content attribute information may not contain all of these pieces of information.

The data schemes 502 to 507 indicate the data schemes in which the providing apparatus 20 can provide the image content to the playback apparatus 30. The data schemes in which the providing apparatus 20 can provide the image content to the playback apparatus 30 are determined based on the correction processing types that the correction processing unit 312 of the providing apparatus 20 can perform, the conversion processing types that the image conversion unit 313 can perform, and the sizes in which the image content can be provided.

The data scheme 502 indicates a data scheme for setting of the same resolution as the RAW data (LARGE size), application of the correction processing “Picture Style/standard”, and conversion into JPEG data. Since the correction processing corresponding to the data scheme 502 is the correction processing that has been set when the image data is captured, the imaging correction flag (DEFAULT_SETTING) is added thereto. The data scheme 503 indicates a data scheme for setting of the same resolution as the RAW data (LARGE size), application of the correction processing “Picture Style/monochrome”, and conversion into JPEG data.

The data scheme 504 indicates a data scheme for setting of the same resolution as the RAW data (LARGE size), application of the correction processing “Picture Style/faithful setting”, and conversion into JPEG data. Since the data scheme 504 is a data scheme for performing no-correction processing on RAW data, the no-correction flag (NO_CORRECTION) flag is added thereto.

The data scheme 505 indicates a data scheme for setting of reduced resolution from the RAW data (SMALL size), application of the correction processing “Picture Style/standard”, and conversion into JPEG data. Since the correction processing corresponding to the data scheme 505 is the correction processing that has been set when the image data is captured, the imaging correction flag (DEFAULT_SETTING) is added thereto. The data scheme 506 indicates a data scheme for setting of reduced resolution from the RAW data (SMALL size), application of the correction processing “Picture Style/monochrome”, and conversion into JPEG data.

The data scheme 507 indicates a data scheme for setting of reduced resolution from the RAW data (SMALL size), application of the correction processing “Picture Style/faithful setting”, and conversion into JPEG data. Since the data scheme 507 is a data scheme for performing no-correction processing on RAW data, the no-correction flag (NO_CORRECTION) is added thereto.

FIG. 6 illustrates an example of the configuration of the content information that the providing apparatus 20 provides to the playback apparatus 30. The DIDL-Lite element 601 indicates the content information as a whole. Actually, the item elements contained in the DIDL-Lite element 601 are the content information about the RAW data 501.

The res elements 602 to 607 are the resource information about the data schemes 502 to 507 illustrated in FIG. 5. In other words, the respective data schemes 502 to 507 illustrated in FIG. 5 correspond to the respective res elements 602 and 607 illustrated in FIG. 6 one-on-one. The resolution attribute contained in the res element 602 indicates the resolution (pixel number) of JPEG data. Further, “contentURI_JPEG_XXX” contained in each res element is an URI indicating an address for acquiring image content (JPEG data) in the data scheme corresponding to the res element.

As these URIs, respective different values are assigned to the res elements 602 to 607. Therefore, the providing apparatus 20 can determine the data scheme of the image content to provide according to the URI specified by the playback apparatus 30. In other words, the providing apparatus 20 determine the correction processing type to apply to the RAW data based on the URI specified by the playback apparatus 30. The text “DLNA.ORG_PN” contained in the protocolInfo attribute value contained in each res element indicates the resolution of JPEG data (image content) prescribed in the DLNA standard. In the present exemplary embodiment, “DLNA.ORG_PN=JPEG_LRG” indicates the largest resolution (LARGE size). On the other hand, “DLNA.ORG_PN=JPEG_SM” indicates the smallest resolution (SMALL size).

Further, “DLNA.ORG_CI” is a flag indicating whether the data is original content. The res element containing “DLNA.ORG_CI=0” corresponds to a data scheme of original content. On the other hand, the res element containing “DLNA.ORG_CI=1” corresponds to a data scheme that is not original content. In the present exemplary embodiment, “original content” refers to a data scheme of image content in which the correction processing that has been set at the time of shooting is performed on the RAW data, and which has the same resolution (pixel number) as the RAW data.

Further, “DLNA.ORG_MI” contained in the protocolInfo attribute value indicates the correction processing type to be performed on the RAW data.

The res element 602 is the res element corresponding to the data scheme 502 illustrated in FIG. 5. The correction information “DLNA.ORG_MI” contains the value indicating “Picture Style/standard” which is the correction processing indicated by the data scheme 502, and the imaging correction flag which indicates the correction processing that has been set at the time of shooting. The correction processing “Picture Style/standard” contains the correction processing (the first color conversion processing) for generating colorful and sharp image content from RAW data (improving a contrast ratio).

The res element 603 is the res element corresponding to the data scheme 503 illustrated in FIG. 5. The correction information “DLNA.ORG_MI” contains the value indicating “Picture Style/monochrome” which is the correction processing indicated by the data scheme 503. The correction processing “Picture Style/monochrome” contains the correction processing (the second color conversion processing) for generating monochromatic image content from RAW data.

The res element 604 is the res element corresponding to the data scheme 504 illustrated in FIG. 5. The correction information “DLNA.ORG_MI” contains the value indicating “Picture Style/faithful setting” which is the correction processing indicated by the data scheme 504, and the no-correction flag indicating that no-correction processing is performed on RAW data. In other words, the processing type indicated by the content information contains the type indicating that RAW data is transmitted without processing applied thereto by the correction processing unit 312.

The res element 605 is the res element corresponding to the data scheme 505 illustrated in FIG. 5. The correction information “DLNA.ORG_MI” contains the value indicating “Picture Style/standard” which is the correction processing indicated by the data scheme 505, and the imaging correction flag which indicates the correction processing that has been set at the time of shooting. The res element 606 is the res element corresponding to the data scheme 506 illustrated in FIG. 5. The correction information “DLNA.ORG_MI” contains the value indicating “Picture Style/monochrome” which is the correction processing indicated by the data scheme 506. The res element 607 is the res element corresponding to the data scheme 507 illustrated in FIG. 5. The correction information “DLNA.ORG_MI” contains the value indicating “Picture Style/faithful setting” which is the correction processing indicated by the data scheme 507, and the no-correction flag indicating that no-correction processing is performed on RAW data.

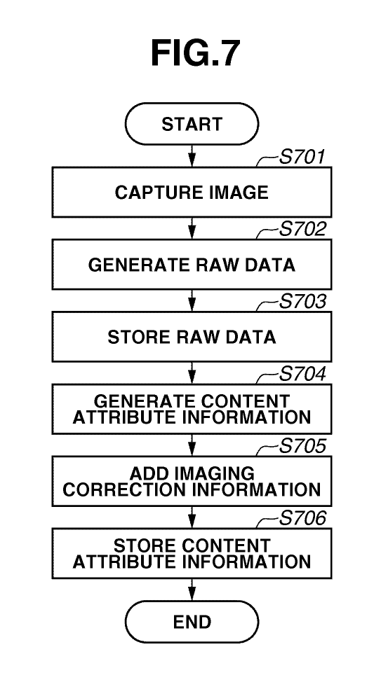

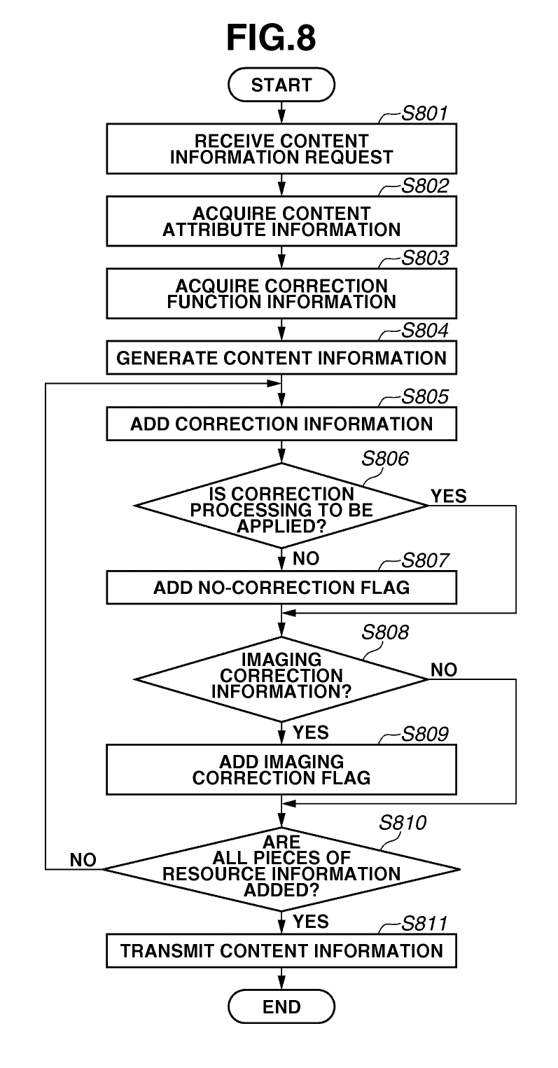

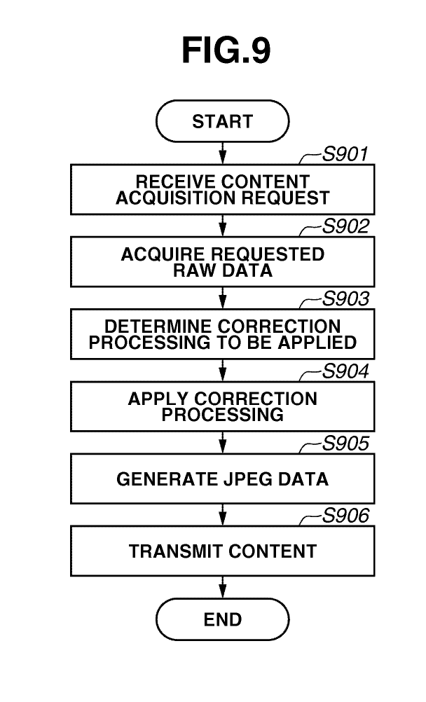

FIG. 7 is a flowchart illustrating the processing when the providing apparatus 20 in the present exemplary embodiment generates the content attribute information. In the present exemplary embodiment, the processing illustrated in FIG. 7 is performed when the digital camera as the providing apparatus 20 captures an object image. Further, in the present exemplary embodiment, the processing illustrated in FIG. 7 is realized by the CPU 201 of the providing apparatus 20 reading out the program stored in the ROM 202 and controlling the respective units accordingly. However, a part or all of the processing illustrated in FIG. 7 may be realized by using dedicated hardware. The flowcharts illustrated in FIGS. 8 and 9, which will be described below, are also programs of the CPU 201 stored in the ROM 202.

In step S701, the imaging unit 311 captures an object image with use of the image sensor 206 illustrated in FIG. 2, and acquires analog electric signal data.

In step S702, the imaging unit 311 acquires digital data (RAW data) from the analog electric signal data acquired in step S701. The present exemplary embodiment is being described based on an example that the providing apparatus 20 acquires RAW data by capturing an object image, but the providing apparatus 20 may acquire RAW data imaged by another apparatus. In step S703, the storage unit 310 stores the RAW data generated in step S702.

In step S704, the imaging unit 311 generates content attribute information about the image data (RAW data) acquired in step S702. The content attribute information contains the shooting data and time of the image data, the model name of the photographing apparatus, the resolution, the shutter speed at the time of shooting, and the identification information (for example, filename) for identifying the image data. However, the content attribute information may not contain a part of them.

In step S705, the correction information addition unit 307 acquires, from the correction processing unit 312, imaging correction information indicating the correction processing type that has been set as a default when the image data is captured in step S701. More specifically, the correction information addition unit 307 acquires the correction function information 1201 illustrated in FIG. 12. Then, the correction information addition unit 307 adds the correction processing type that has been set when the image data is captured to the content attribute information according to the acquired imaging correction information.

In step S706, the storage unit 310 stores the content attribute information generated in step S705 together with the RAW data acquired in step S702.

FIG. 8 is a flowchart illustrating the processing when the providing apparatus 20 in the present exemplary embodiment receives a content information request from the playback apparatus 30 via the LAN 10.

In step S801, the SOAP processing unit 303 receives a content information request from the playback apparatus 30 via the LAN 10. More specifically, the SOAP processing unit 303 receives a Browse action of CDS from the playback apparatus 30.

In step S802, the content information generation unit 306 acquires, from the storage unit 310, the content attribute information of the image data corresponding to the content information request received in step S801.

For example, if a filename is contained in the content information request received in step S801, the content information generation unit 306 acquires, from the storage unit 310, the content attribute information about the image data corresponding to that filename. On the other hand, if a shooting date and time is contained in the content information request received in step S801, the content information generation unit 306 acquires, from the storage unit 310, the content attribute information about the image data captured on that shooting date and time.

The content attribute information acquired in step S802 contains the filename for identifying the image data, the shooting date and time, the model name of the photographing apparatus, the resolution, the shutter speed, and the information about the correction processing type that has been set at the time of shooting. However, the content attribute information may not contain a part of these pieces of information. In step S803, the correction information addition unit 307 acquires the correction function information from the correction processing unit 312. The correction function information is the information indicating the correction processing types that the correction processing unit 312 can perform on the image data. The processing in step S802 and the processing in step S803 may be performed concurrently, or may be performed in the reverse order.

In step S804, the content information generation unit 306 generates the content information in the DIDL-Lite format based on the content attribute information acquired in step S802. The content information generated in step S804 is the content information which is illustrated in FIG. 6, but does not yet contain the res elements 603 to 607, the imaging correction flag, and the no-correction flag.

In step S805, the correction information addition unit 307 generates one res element (resource information) based on the correction function information acquired in step S803, and adds it to the content information. More specifically, the correction information addition unit 307 generates correction information (for example, 402 illustrated in FIG. 4) based on one piece of the correction function information (for example, 1202 illustrated in FIG. 12) acquired in step S803 to generate a res element (for example, the res element 603 illustrated in FIG. 6). However, a plurality of res elements (for example, the res elements 603 and 606 illustrated in FIG. 6) may be generated based on one piece of the correction function information (for example, 1202 illustrated in FIG. 12).

In step S806, the correction flag addition unit 308 determines whether the res element added in step S805 is a res element that performs correction processing on the RAW data. In the present exemplary embodiment, if the res element contains the type “Picture Style/faithful setting”, the correction flag addition unit 308 determines that the res element added instep S805 is a res element that does not perform correction processing (NO in step S806), and then the operation proceeds to step S807. On the other hand, if the correction flag addition unit 308 determines that the res element added in step S805 is a res element that performs correction processing (YES in step S806), the operation proceeds to step S808. In step S807, the correction flag addition unit 308 adds the no-correction flag to the res element added in step S805.

In step S808, the imaging correction flag addition unit 309 determines whether the res element added in step S805 is a res element that performs the correction processing that has been set at the time of shooting. In the present exemplary embodiment, if the res element contains the type “Picture Style/standard”, the imaging correction flag addition unit 309 determines that the res element added in step S805 is a res element that performs the correction processing that has been set at the time of shooting (YES in step S808), and then the operation proceeds to step S809. On the other hand, if the imaging correction flag addition unit 309 determines that the res element added in step S805 is not a res element that performs the correction processing that has been set at the time of shooting (NO in step S808), the operation proceeds to step S810. In step S809, the imaging correction flag addition unit 309 adds the imaging correction flag to the res element added in step S805.

In step S810, the correction information addition unit 307 determines whether all of the res elements (resource information) are added. If the correction information addition unit 307 determines that all of the res elements are added (YES in step S810), the operation proceeds to step S811. On the other hand, if the correction information addition unit 307 determines that not all of the res elements are added (NO in step S810), the operation returns to step S805, in which the correction information addition unit 307 adds the next res element.

In step S811, the SOAP processing unit 303 transmits the content information to the playback apparatus 30. More specifically, the SOAP processing unit 303 transmits the content information to the playback apparatus 30 as a response to the Brower action of CDS.

In other words, the SOAP processing unit 303 transmits the content information containing the plurality of processing types that the correction processing unit 312 can perform to the playback apparatus 30 as a response to the request (content information request) from the playback apparatus 30. The content information contains the imaging correction flag by which the playback apparatus 30 can identify the processing type that has been set when the imaging unit 311 acquires the digital data (RAW data) from among the plurality of processing types that the correction processing unit 312 can perform. Further, the playback apparatus 30, which has received the content information, can determine the processing to be performed by the correction processing unit 312 from among the plurality of processing types that the correction processing unit 312 can perform.

FIG. 9 is a flowchart illustrating the processing when the providing apparatus 20 receives a content request from the playback apparatus 30 via the LAN 10.

In step S901, the control unit 305 receives a content request from the playback apparatus 30, which has received the content information. The content request contains a URI. The URI corresponds to the identification information of the image content and the data scheme of the image data one-on-one. In other words, the content request contains specification information for specifying the processing type to be actually performed from the processing types that the correction processing unit 312 can perform.

In step S902, the correction processing unit 312 acquires, from the storage unit 310, the RAW data corresponding to the image content requested by the play back apparatus 30 based on the URI acquired in step S901. In step S903, the correction information addition unit 307 determines the processing type to be performed on the RAW data acquired in step S902 based on the URI acquired in step S901.

In step S904, the correction information addition unit 307 requests the correction processing unit 312 to perform the correction processing determined in step S903. Then, the correction processing unit 312 performs the correction processing on the RAW data acquired in step S902 in response to the request from the correction information addition unit 307. The correction processing unit 312 in the present exemplary embodiment performs the correction processing related to Picture Style on the RAW data. The correction processing related to Picture Style contains the processing of correcting sharpness, contrast, color strength, and color tone.

In step S905, the image conversion unit 313 converts the image data with the correction processing applied thereto in step S904 into JPEG data to generate image content. In step S906, the control unit 305 transmits the image content (JPEG data) generated by the processing of the correction processing unit 312 and the image conversion unit 313 to the playback apparatus 30 via the LAN communication control unit 301.

The providing apparatus 20 in present exemplary embodiment has been described based on an example that the providing apparatus 20 provides the content information indicating the six types of data schemes that the providing apparatus 20 can provide to the playback apparatus 30. The playback apparatus 30 can recognize the correction processing types that the providing apparatus 20 can perform, by referring to the information about the data schemes contained in the received content information.

Therefore, the playback apparatus 30 can recognize what kind of correction processing has been performed on the digital data (RAW data), with respect to the content (image content) provided by the providing apparatus 20. Further, the playback apparatus 30 can select the data scheme suitable for the status of the playback apparatus 30 from among the data schemes that the providing apparatus 20 can provide. The status of the playback apparatus 30 includes, for example, the environment in which the playback apparatus 30 is placed and the settings of the playback apparatus 30.

Further, the providing apparatus 20 in the present exemplary embodiment collectively provides image contents in a plurality of data schemes based on one piece of RAW data as one piece of content information to the playback apparatus 30. Collectively providing one piece of content information makes processing related to, for example, generation and management of the content information easier than providing the content information pieces of the number corresponding to the number of the data schemes that the providing apparatus 20 can provide. Further, collectively providing one piece of content information enables a user to easily select image content that the user wants to view, compared to providing a plurality of pieces of content information in which the user should regard image contents in different data schemes as different image contents for the respective data schemes.

For example, if the providing apparatus 20, upon reception of a content information request containing a shooting date, provides content information for each data scheme for a plurality of pieces of image data corresponding to the shooting date to the playback apparatus 30, this may result in a display of a large number of thumbnails on the playback apparatus 30. In other words, if there are ten pieces of image data captured on the specified shooting date, and there are six types of data schemes that the providing apparatus 20 can provide, this may result in a display of 60 thumbnail images on the playback apparatus 30. On the other hand, according to the present exemplary embodiment, since data schemes corresponding to one piece of RAW data can be collectively provided to the playback apparatus 30 as one piece of content information, only ten thumbnail images are displayed on the playback apparatus 30. In sum, the providing apparatus 20 and the playback apparatus 30 can handle image contents based on one piece of RAW data as one image content regardless of the number of data schemes.

Next, the configuration and the operation of the playback apparatus 30 in the present exemplary embodiment will be described. The hardware configuration of the playback apparatus 30 in the present exemplary embodiment is similar to the configuration illustrated in FIG. 2.

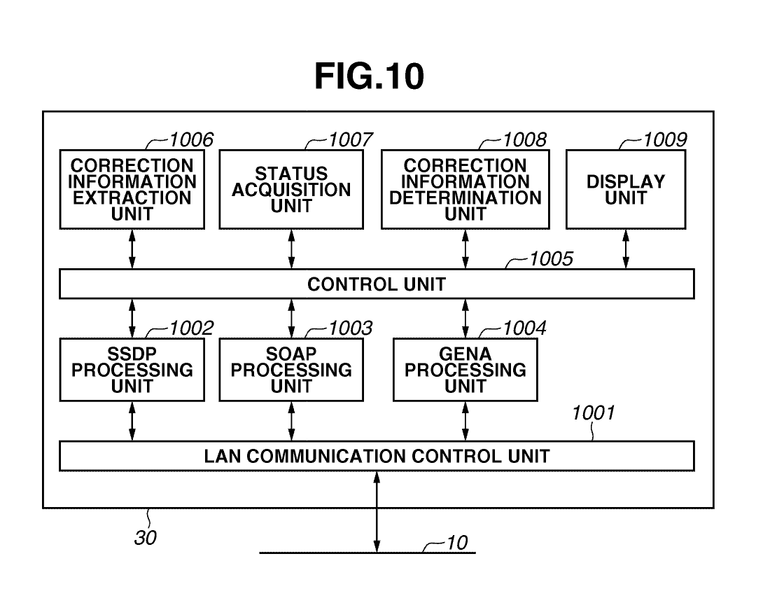

FIG. 10 is a block diagram illustrating an example of the module configuration of the playback apparatus 30. The playback apparatus 30 is a playback apparatus that plays back image content received from the providing apparatus 20 via the network.

A LAN communication control unit 1001 is in charge of communication control for enabling a connection to the LAN 10.

An SSDP processing unit 1002 performs the SSDP processing of UPnP via the LAN communication control unit 1001. Especially, the SSDP processing unit 1002 discovers the providing apparatus 20 existing in LAN 10. More specifically, the SSDP processing unit 1002 transmits a message (M-SEARCH message) for searching a DLNA apparatus existing in the LAN 10. Further, the SSDP processing unit 1002 receives an advertisement message (alive message) for indicating the existence of the providing apparatus 20 as a DMS in the LAN 10. The present exemplary embodiment utilizes the SSDP processing, but the present invention is not limited thereto. The playback apparatus 30 may use another method such as the WS-Discovery technology or the MAC address technology.

An SOAP processing unit 1003 performs the SOAP processing of UPnP via the LAN communication control unit 1001. Especially, the SOAP processing unit 1003 transmits a content information request and a content request to the providing apparatus 20. The content information request is a request for acquiring content information as illustrated in FIG. 6. The content request is a request for image content and contains a URI. The present exemplary embodiment utilizes the SOAP processing, but the present invention is not limited thereto. The playback apparatus 30 may use another method for carrying out a remote object such as the Remote Procedure Call technology.

A GENA processing unit 1004 performs the GENA processing of UPnP via the LAN communication control unit 1001. Especially, the GENA processing unit 1004 subscribes to an event of the providing apparatus 20, and receives an event issued by the providing apparatus 20. The present exemplary embodiment utilizes the GENA processing, but the present invention is not limited thereto. The playback apparatus 30 may use another method such as the WS-Eventing technology or the WS-Notification technology.

A control unit 1005 is in charge of overall control of the playback apparatus 30. In addition, the control unit 1005 manages and controls the modules 1001 to 1009.

A correction information extraction unit 1006 extracts the correction information contained in the content information acquired from the providing apparatus 20. The correction information is contained in a res element (resource information). The correction information extraction unit 1006 in the present exemplary embodiment acquires the three types of correction information “Picture Style/standard”, “Picture Style/monochrome”, and “Picture Style/faithful setting” from the content information illustrated in FIG. 6. The correction information extraction unit 1006 in the present exemplary embodiment extracts “DLNA.ORG_MI” contained in the res elements 602 to 607 (resource information) after acquiring the content information as illustrated in FIG. 6.

A status acquisition unit 1007 acquires the current status of the playback apparatus 30. The status acquisition unit 1007 in the present exemplary embodiment acquires at least one status of the following statuses as the current status of the playback apparatus 30.

The first status is the status about the display characteristic of a display unit 1009 which displays image content. The display characteristic is parameters of the display unit 1009 such as luminance, contrast, gamma, and color temperature. In other words, the status acquisition unit 1007 acquires the setting information about the setting of the playback screen on which image content is played back.

The second status is the status about the viewing environmental characteristic of the location where the playback apparatus 30 is placed. The viewing environmental characteristic is parameters according to the ambient light surrounding the playback screen on which image content is played back, such as brightness of illumination and color temperature of illumination. In other words, the status acquisition unit 1007 acquires the ambient light information about the ambient light surrounding the playback screen on which image content is played back. The status acquisition unit 1007 in the present exemplary embodiment acquires the ambient light information with use of a sensor, but the present invention is not limited thereto. For example, the status acquisition unit 1007 may acquires the ambient light information through an input of a user.

The third status is the status about the setting of the display function for displaying a content on the playback apparatus 30. The setting of the display function is parameters about the setting of the application in the playback apparatus 30, such as the faithful display mode, the monochromatic display mode, and the imaging correction setting mode.

A correction information determination unit 1008 determines optimum correction information from among a plurality of types of correction information extracted by the correction information extraction unit 1006 based on the status of the playback apparatus 30 acquired by the status acquisition unit 1007. The determination of the correction information leads to determination of the correction processing type to be performed on the RAW data.

For example, it is assumed that the status acquisition unit 1007 acquires a status indicating that the display characteristic is bright and high-definition as the status about the display characteristic of the display unit 1009. In this case, the correction information determination unit 1008 determines the correction information containing the no-correction flag from the extracted correction information as the optimum correction information. On the other hand, if the status acquisition unit 1007 acquires a status indicating that the display characteristic is dark as the status about the display characteristic of the display unit 1009, the correction information determination unit 1008 determines “Picture Style/standard” from the extracted correction information as the optimum correction information. “Picture Style/standard” corresponds to the correction information for obtaining colorful and sharp image content from RAW data.

Further, for example, it is assumed that the status acquisition unit 1007 acquires a status indicating that the viewing environment is dark as the status about the viewing environmental characteristic. In this case, the correction information determination unit 1008 determines “Picture Style/standard” from the extracted correction information as the optimum correction information. On the other hand, it is assumed that the status acquisition unit 1007 acquires a status indicating that the viewing environment is bright as the status about the viewing environmental characteristic. In this case, the correction information determination unit 1008 determines the correction information containing the no-correction flag (“Picture Style/faithful setting”) from the extracted correction information as the optimum correction information.

Further, for example, it is assumed that the status acquisition unit 1007 acquires a status indicating that the monochromatic display mode is set as the status about the display function setting. In this case, the correction information determination unit 1008 determines “Picture Style/monochrome” corresponding to the correction processing for generating monochromtic image content from RAW data from the extracted correction information as the optimum correction information.

The correction information determination unit 1008 can acquire a plurality of statuses and determine the correction information by preferentially selecting any of them.

For example, if the monochromatic display mode is set to the playback apparatus 30, the correction information determination unit 1008 determines “Picture Style/monochrome” as the optimum correction information regardless of the viewing environmental characteristic.

Further, the correction information determination unit 1008 can even determine the correction information based on a combination the above-described plurality of statuses. The correction information determination unit 1008 can set a priority order to each of the plurality of statuses, and determine the correction information by weighting the statuses according to the respective priority orders. The display unit 1009 is a display on which the acquired image content is displayed.

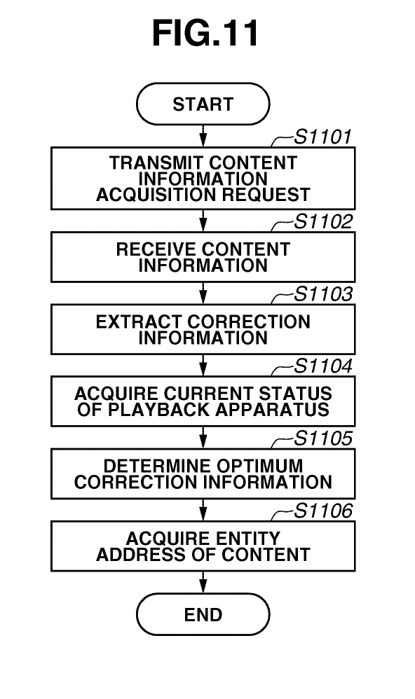

FIG. 11 is a flowchart illustrating the processing by the playback apparatus 30 in the present exemplary embodiment. In the present exemplary embodiment, the processing illustrated in FIG. 11 is realized by the CPU 201 of the playback apparatus 30 reading out the program stored in the ROM 202 and controlling the respective units accordingly. However, a part or all of the processing illustrated in FIG. 11 may be realized by using dedicated hardware.

In step S1101, the SOAP processing unit 1003 transmits a content information request to the providing apparatus 20 via the LAN 10. More specifically, the SOAP processing unit 1003 transmits a Browse action of CDS to the providing apparatus 20. In step S1102, the SOAP processing unit 1003 receives content information from the providing apparatus 20. More specifically, the SOAP processing unit 1003 receives a response to the Browse action of CDS from the providing apparatus 20.

In step S1103, the correction information extraction unit 1006 extracts the correction information based on the content information acquired in step S1102. More specifically, the correction information extraction unit 1006 acquires the information about the processing types that the providing apparatus 20 can perform on the digital data (RAW data) in step S1103. The correction information extraction unit 1006 in the present exemplary embodiment extracts the three types of correction information “Picture Style/standard”, “Picture Style/monochrome”, and “Picture Style/faithful setting”.

In step S1104, the status acquisition unit 1007 carries out at least any one of the following operations as acquisition of the current status of the playback apparatus 30: acquisition of the status about the display characteristic (setting information) (status acquisition); acquisition of the status about the viewing environmental characteristic (for example, ambient light information) (environment acquisition); and acquisition of the status about the display function setting.

In step S1105, the correction information determination unit 1008 determines the optimum correction information from among the plurality of types of correction information extracted in step S1103 based on the status acquired in step S1104.

In step S1106, the correction information determination unit 1008 determines one res element from among the res elements (resource information) containing the optimum correction information determined in step S1105, and acquires the URI from the determined res element. In other words, the correction information determination unit 1008 determines the processing type that the playback apparatus 30 causes the providing apparatus 20 to perform from among the plurality of types of processing indicated in the content information. The correction information determination unit 1008 in the present exemplary embodiment determines one res element based on the resolution, when there is a plurality of res elements corresponding to the optimum correction information. Further, in step S1106, the correction information determination unit 1008 transmits a content request containing the acquired URI to the providing apparatus 20 via the LAN communication control unit 1001.

As described above, the playback apparatus 30 acquires content information from the providing apparatus 20. Then, the playback apparatus 30 determines the correction information for applying the optimum correction processing from the correction information contained in the acquired content information based on the current status of the playback apparatus 30.

According to the present exemplary embodiment of the present invention, the playback apparatus 30 can play back content with the processing more suitable for the status of the playback apparatus 30 applied thereto. For example, when the display characteristic of the display unit 1009 is dark, the playback apparatus 30 can request, to the providing apparatus 20, image content resulting from application of correction processing for making RAW data more colorful and sharp.

Further, the playback apparatus 30 can determine processing to be performed by the providing apparatus 20, based on a combination of the display characteristic of the display unit 1009, the viewing environmental characteristic, and the display function setting. As a result, for example, even if the viewing environmental characteristic (ambient light) of the display unit 1009 is comparatively bright, if the display characteristic of the display screen is comparatively dark, the playback apparatus 30 can determine the optimum correction processing for obtaining sharper image content.

Further, the correction information determination unit 1008 of the playback apparatus 30 can determine correction information for applying no-correction processing by selecting correction information containing the no-correction flag. This enables a reduction in the load of processing for comparing the details of the correction information in the playback apparatus 30.

Further, the correction information determination unit 1008 of the playback apparatus 30 can determine correction information for applying the correction processing that has been set when the image data (RAW data) is generated, by selecting correction information containing the imaging correction flag. This enables a reduction in the load of processing for comparing the details of the correction information in the playback apparatus 30.

The present exemplary embodiment has been described based on an example in which the processing type of correcting sharpness, contrast, color strength, and color tone is determined according to the correction processing type related to Picture Style. For example, if Picture Style/standard is selected, the processing according to the setting at the time of shooting is applied for all of the items sharpness, contrast, color strength, and color tone. However, the present invention may be configured so that the correction processing types are specified for the respective items separately. In this case, for example, the playback apparatus 30 can request the providing apparatus 20 to perform the processing type that has been set at the time of shooting for the items sharpness and contrast but perform no processing for the items color strength and color tone.

More specifically, the playback apparatus 30 transmits, to the providing apparatus 20, specification information for specifying first processing (sharpness correction processing) that has been set when the imaging unit 311 acquires the digital data (RAW data), and second processing (color strength correction processing) that has not been set when the imaging unit 311 acquires the digital data. If the providing apparatus 20 receives such specification information, the correction processing unit 312 transmits image content resulting from application of the respectively specified first and second processing to the playback apparatus 30 via the LAN communication control unit 301.

Further, the providing apparatus 20 in the present exemplary embodiment transmits the content information together with the image content to the playback apparatus 30 when the providing apparatus 20 provides image content in response to a content request from the playback apparatus 30. This enables the playback apparatus 30 to transmit a new content request to the providing apparatus 20 after reselecting the optimum correction processing, for example, when some change occurs in the viewing environment surrounding the playback apparatus 30.

Further, the present exemplary embodiment has been described based on an example in which an optimum status is determined based on the status acquired by the status acquisition unit 1007, but the present invention is not limited thereto. For example, the control unit 1005 of the playback apparatus 30 may display the processing types that the providing apparatus 20 can perform on the display unit 1009 upon reception of the content information so that a user can select a processing type from among the displayed processing types. In this case, the user inputs the processing type that the user causes the providing apparatus 20 to perform from among the processing types displayed on the display unit 1009 with use of a not-shown input unit (for example, a mouse or a keyboard). Then, the correction information determination unit 1008 determines a processing type that the playback apparatus 30 causes the providing apparatus 20 to perform, based on an input via the input unit.

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment (s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-037670 filed Feb. 23, 2010, which is hereby incorporated by reference herein in its entirety.

What is claimed is:

1. An apparatus comprising:
an acquisition unit configured to acquire digital data;
a processing unit configured to perform a plurality of processing types to generate content from the acquired digital data; and
a transmission unit configured to transmit, to a playback apparatus in response to a request from the playback apparatus, content information for enabling the apparatus to recognize the plurality of processing types that the processing unit can perform and a processing type that has been set when the digital data is acquired, so as to enable the playback apparatus to determine processing type to be performed.

2. The apparatus according to claim 1, further comprising a reception unit configured to receive specification information for specifying a processing type from the playback apparatus that has received the content information,
wherein the processing unit performs the specified processing type on the acquired digital data, and
wherein the transmission unit transmits the generated content to the playback apparatus.

3. The apparatus according to claim 2, wherein, if the reception unit receives the specification information for specifying first processing that has been set when the digital data is acquired and second processing that has not been set when the digital data is acquired, the transmission unit transmits the generated content to the playback apparatus.

4. The apparatus according to claim 2, wherein the transmission unit transmits, to the playback apparatus, the content information together with the content generated by execution of the processing type specified by the specification information on the acquired digital data.

5. The apparatus according to claim 1, wherein the processing types indicated by the content information include a processing type corresponding to first color conversion processing for generating image content by improving a contrast ratio of image data acquired by the acquisition unit, and a processing type corresponding to second color conversion processing for generating monochromatic image content from the acquired image data.

6. The apparatus according to claim 1, wherein the processing types include a processing type indicating transmission of image data acquired by the acquisition unit without processing performed thereon by the processing unit.

7. The apparatus according to claim 1, wherein the processing types include a processing type corresponding to first pixel number conversion processing for converting image data acquired by the acquisition unit so that the image data has a first number of pixels, and a processing type corresponding to second pixel number conversion processing for converting the acquired image data so that the image data has a second number of pixels smaller than the first number of pixels.

8. The apparatus according to claim 1, wherein the apparatus is a playback apparatus.

9. An apparatus comprising:
a reception unit configured to receive, from a content providing apparatus, content information for enabling recognition of a plurality of processing types that the content providing apparatus can perform on digital data that the content providing apparatus generates content from the digital data, and a processing type that has been set when the digital data is acquired;
a determination unit configured to determine a processing type that the apparatus causes the content providing apparatus to perform from among the processing types indicated by the received content information; and
a transmission unit configured to transmit specification information for specifying the determined processing type to the content providing apparatus.

10. The apparatus according to claim 9, further comprising a status acquisition unit configured to acquire setting information about a setting of a playback screen on which image content received from the content providing apparatus is played back,
wherein the determination unit determines the processing type that the apparatus causes the content providing apparatus to perform based on the acquired setting information.

11. The apparatus according to claim 9, further comprising an environment acquisition unit configured to acquire ambient light information about ambient light surrounding a playback screen on which image content received from the content providing apparatus is played back,
wherein the determination unit determines the processing type that the apparatus causes the content providing apparatus to perform based on the acquired ambient light information.

12. The apparatus according to claim 9, further comprising:
a display control unit configured to display the processing types indicated by the received content information on a display screen; and
an input unit configured to input a processing type selected as the processing type that the apparatus causes the content providing apparatus to perform from among the processing types displayed on the display screen,
wherein the determination unit determines the processing type that the apparatus causes the content providing apparatus to perform based on an input via the input unit.

13. A method comprising:
acquiring digital data;
performing a plurality of processing types to generate content from the acquired digital data; and
transmitting, to an apparatus in response to a request from the apparatus, content information for enabling the apparatus to recognize the processing types and a processing type that has been set when the digital data is acquired from the processing types, so as to enable the apparatus to determine processing to be performed.

14. A computer-readable storage medium storing a computer-executable program of instructions for causing a computer to perform a method comprising:
acquiring digital data;
performing a plurality of processing types to generate content from the acquired digital data; and
transmitting, to an apparatus in response to a request from the apparatus, content information for enabling the apparatus to recognize the processing types and a processing type that has been set when the digital data is acquired from the processing types, so as to enable the apparatus to determine processing to be performed.

15. A method comprising:
receiving, from a content providing apparatus, content information for enabling recognition of a plurality of processing types that the content providing apparatus can perform on digital data that the content providing apparatus generates content from the digital data, and a processing type that has been set when the digital data is acquired;
determining a processing type that an apparatus causes the content providing apparatus to perform from among the processing types indicated by the received content information; and
transmitting specification information for specifying the determined processing type to the content providing apparatus.

16. A computer-readable storage medium storing a computer-executable program of instructions for causing a computer to perform a method comprising:
receiving, from the content providing apparatus, content information for enabling recognition of a plurality of processing types that the content providing apparatus can perform on digital data that the content providing apparatus generates content from the digital data, and a processing type that has been set when the digital data is acquired;
determining a processing type that the apparatus causes the content providing apparatus to perform from among the processing types indicated by the received content information; and
transmitting specification information for specifying the determined processing type to the content providing apparatus.
